(19) United States
(12) Patent Application Publication
(10) Pub. No.: US 2007/0215559 A1
(43) Pub. Date: Sep. 20, 2007

(54) Automotive Fluid Filter with Sintered Pellet Filter Medium and Associated Method

(75) Inventors: Ledu Q. NGUYEN, Fayetteville, NC (US); Allen B. WRIGHT, Hope Mills, NC (US)

Correspondence Address: CROWELL & MORING LLP;INTELLECTUAL PROPERTY GROUP, P.O. BOX 14300, WASHINGTON, DC, 20044-4300, US

(73) Assignee: PUROLATOR FILTERS NA LLC, Fayetteville, NC (US)

(21) Appl. No.: 11/744,485

(22) Filed: May 4, 2007

Related U.S. Application Data
(62) Division of application No. 10/931,652, filed on Sep. 1, 2004.

(51) Int. Cl. B01D 29/00

(52) U.S. Cl. 210/767

(57) ABSTRACT

An automotive fluid filter comprises a plurality of pellets that are sintered together and define a plurality of pores therebetween for passage of automotive fluid through the pores so as to filter the automotive fluid when the automotive fluid is advanced therethrough. An associated method is disclosed.

This application is a divisional of pending U.S. patent application Ser. No. 10/931,652, filed Sep. 1, 2004, the disclosure of which is expressly incorporated by reference herein.

### CROSS-REFERENCE TO RELATED APPLICATION

Cross-reference to commonly assigned U.S. patent application Ser. No. ______ (attorney docket no. 102513.57943D2), tilted AUTOMOTIVE FLUID FILTER WITH SINTERED PELLET FILTER MEDIUM AND ASSOCIATED METHOD, filed May 4, 2007, is hereby made.

### FIELD OF THE DISCLOSURE

The present disclosure relates generally to automotive fluid filters.

### BACKGROUND OF THE DISCLOSURE

The filter medium of an automotive fluid filter is used to filter an automotive fluid. Oftentimes, at the end of the useful life of a filter medium, the filter medium is disposed of and not recycled as its components may not be conducive to recycling.

### SUMMARY

According to an aspect of the present disclosure, there is provided an automotive fluid filter. A filter medium of the automotive fluid filter comprises pellets that are sintered together and define a plurality of pores therebetween for passage of automotive fluid through the pores so as to filter the automotive fluid when the automotive fluid is advanced therethrough. The pellets can be recycled to create another filter medium. An associated method is disclosed.

The above and other features of the present disclosure will become apparent from the following description and the attached drawings.

### BRIEF DESCRIPTION OF THE DRAWINGS

The detailed description particularly refers to the following figures in which:

FIG. 1 is a diagrammatic view showing advancement of unfiltered automotive fluid through a sintered pellet filter medium of an automotive fluid filter so as to filter the automotive fluid for passage to an automotive system of an automotive vehicle;

FIG. 2 is a diagrammatic view showing recycling and re-use of a used sintered pellet filter medium;

FIG. 3 is a sectional view showing the automotive fluid filter embodied as an air filter that comprises an air filter element mounted in a housing for passage of air through a panel-shaped sintered pellet filter medium;

FIG. 4 is an exploded perspective view of the air filter element showing the panel-shaped sintered pellet filter medium and a gasket to be secured thereto;

FIG. 5 is an enlarged sectional view showing that, in one example, the pellets of the panel-shaped sintered pellet filter medium are generally uniform in size and define pores therebetween for passage of air through the pores;

FIG. 6 is an enlarged sectional view similar to FIG. 5 showing that, in another example, the panel-shaped sintered pellet filter medium comprises a number (e.g., four) of layers comprising pellets of different sizes to filter particles of different sizes;

FIG. 7 is a sectional view showing the automotive fluid filter embodied as an automotive liquid filter comprising an automotive liquid filter element positioned in a filter chamber of a housing for passage of an automotive liquid through a hollow cylinder sintered pellet filter medium;

FIG. 8 is an exploded perspective view of the automotive liquid filter element showing the filter medium between a pair of end caps;

FIG. 9 is a top plan view showing that, in one example, the hollow cylinder sintered pellet filter medium is pleated and comprises pellets of uniform size;

FIG. 10 is a top plan view showing that, in another example, the hollow cylinder sintered pellet filter medium comprises a number (e.g., four) of adjacent layers comprising pellets of different sizes to filter particles of different sizes;

FIG. 11 is a sectional view showing an end cap secured to pellets of the filter medium of FIG. 10;

FIG. 12 is a top plan view showing that, in another example, the hollow cylinder sintered pellet filter medium comprises a number (e.g., four) of layers spaced apart from one another to define particle accumulation chambers therebetween; and

FIG. 13 is a sectional view showing an end cap secured to pellets of the filter medium of FIG. 12.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the disclosure to the particular forms disclosed, but on the contrary, the intention is to cover all modifications, equivalents, and alternatives following within the spirit and scope of the invention as defined by the appended claims.

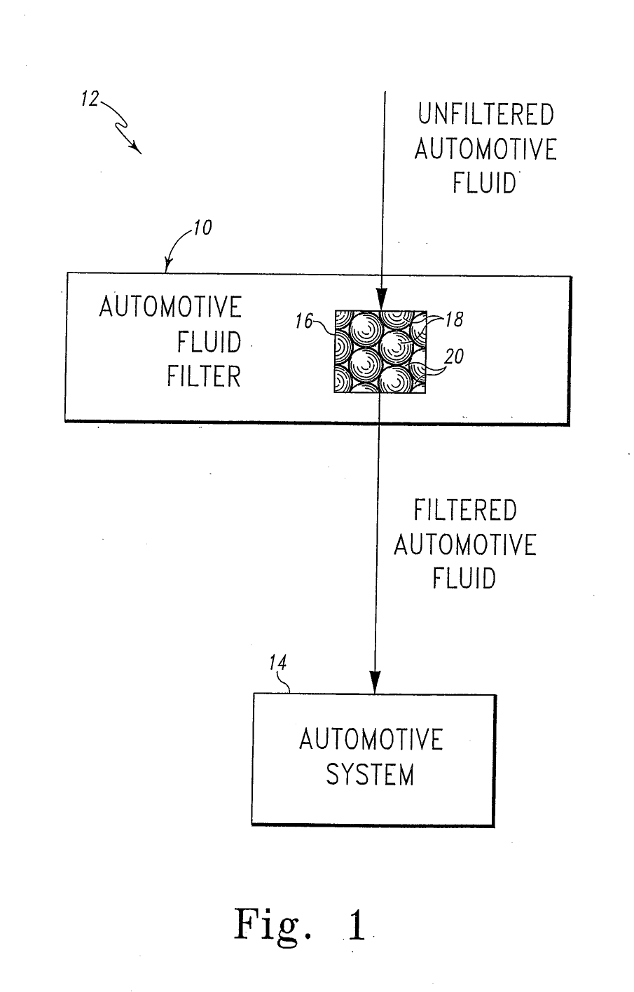

Referring to FIG. 1, an automotive fluid filter 10 of an automotive vehicle 12 is used to filter unfiltered automotive fluid to provide filtered automotive fluid to an automotive system 14 (e.g., internal combustion engine, transmission, hydraulic system). A filter medium 16 of the filter 10 comprises a plurality of pellets 18 that are sintered together and define a plurality of pores 20 between the pellets 18 to filter automotive fluid upon passage of the automotive fluid through the pores 20. The pellets 18 are sintered together in the sense that that the pellets 18 are heated so that the outer surfaces of adjacent pellets 18 join together without the pellets 18 melting.

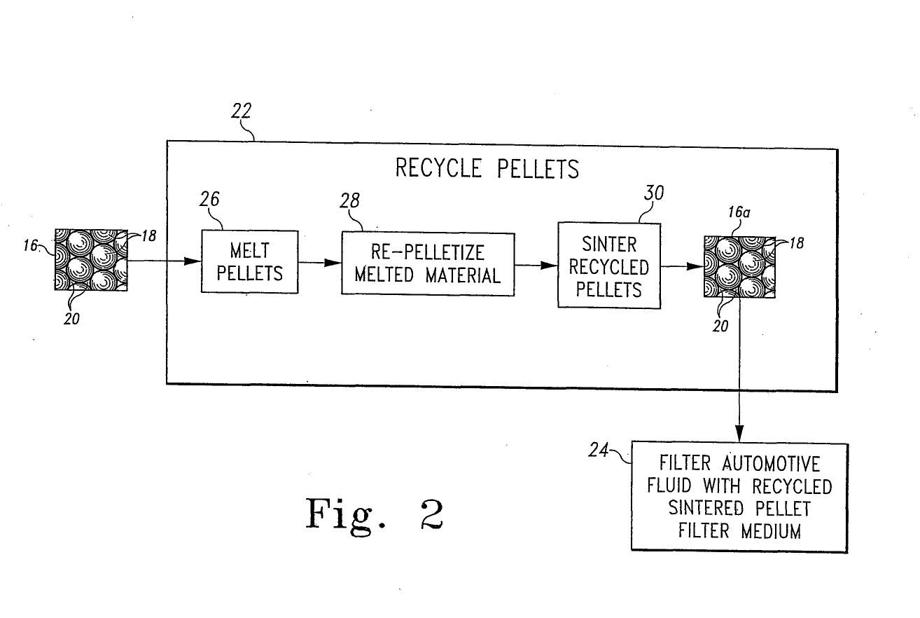

Referring to FIG. 2, the filter medium 16 can be recycled (recycling step 22) and re-used (re-use step 24) when the filter medium 16 comprises pellets 18 made of recyclable material. For example, meltable pellets 18 are melted into a melted material (melting step 26). The melted material is re-pelletized to produce a set of recycled pellets 18 (re-pelletizing step 28). The recycled pellets 18 are sintered together to produce another filter medium 16a (sintering step 30). The new sintered pellet filter medium 16a is then used in an automotive filter 10 to filter automotive fluid (re-use step 24). The pellets 18 may be made, for example, of a polymeric material or a ceramic material.

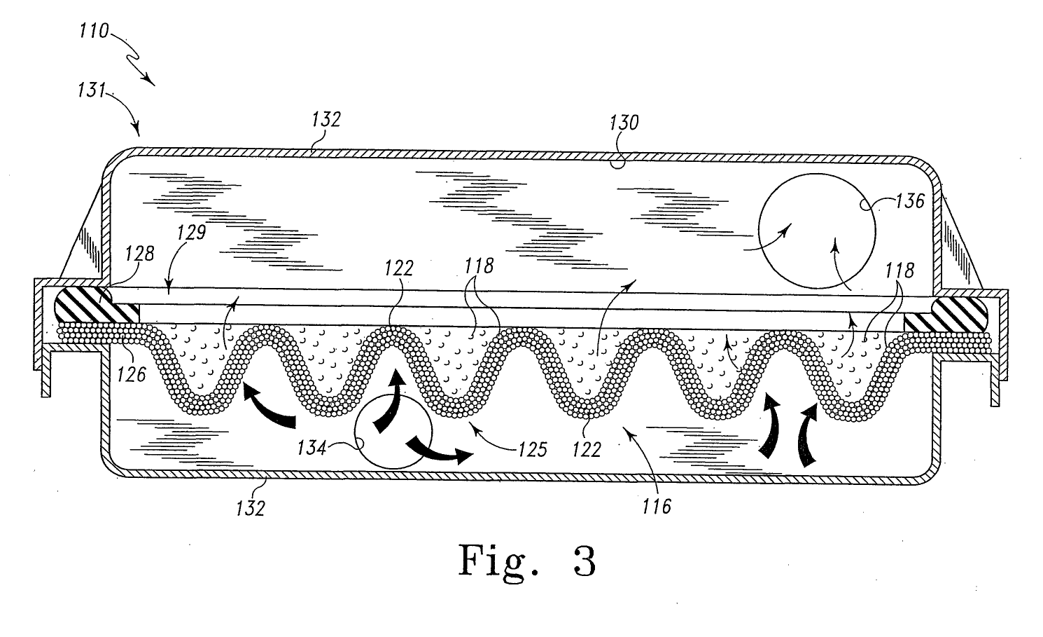

Referring to FIG. 3, according to an exemplary implementation, the automotive fluid filter 10 is embodied, for example, as an air filter 110 and the automotive fluid filter medium 16 is embodied, for example, as a panel-shaped filter medium 116. The filter medium 116 comprises a plurality of pellets 118 that are sintered together and define a plurality of pores 120 between the pellets 118 to filter air that is advanced through the pores 120. The sintered pellets 118 are made, for example, of nylon.

The sintered pellets 118 provide the filter medium 116 with a pleated panel 125 and a perimeter flange 126. The pleated panel 125 comprises plurality of pleats 122 for increasing filter surface area and spaced-apart pleat support walls 124 secured to opposite ends of the pleats 122 to support the pleats 122. The perimeter flange 126 is secured to and surrounds the pleated panel 125. A gasket 128 made, for example, of rubber, urethane, or the like is secured to the perimeter flange 126 by a suitable process (e.g., thermal bonding, chemical bonding, sonic welding, use of infrared or flame heat, to name just a few). Together, the filter medium 116 and the gasket 128 provide a filter element 129.

The filter element 129 is secured to a housing 131 upon sandwiching the perimeter flange 126 and the gasket 128 between housing shells 132. In this way, the filter medium 116 is mounted in a fixed position in a filter chamber 130 defined in the housing 131 by the shells 132 to filter air flowing from an air inlet 134 defined in one of the shells 132 through the pores 120 defined between the pellets 118 to an air outlet 136 defined in the other shell 132. It is within the scope of this disclosure to shorten the perimeter flange 126 or lengthen the gasket 128 so that only the gasket 128 is sandwiched between the shells 132.

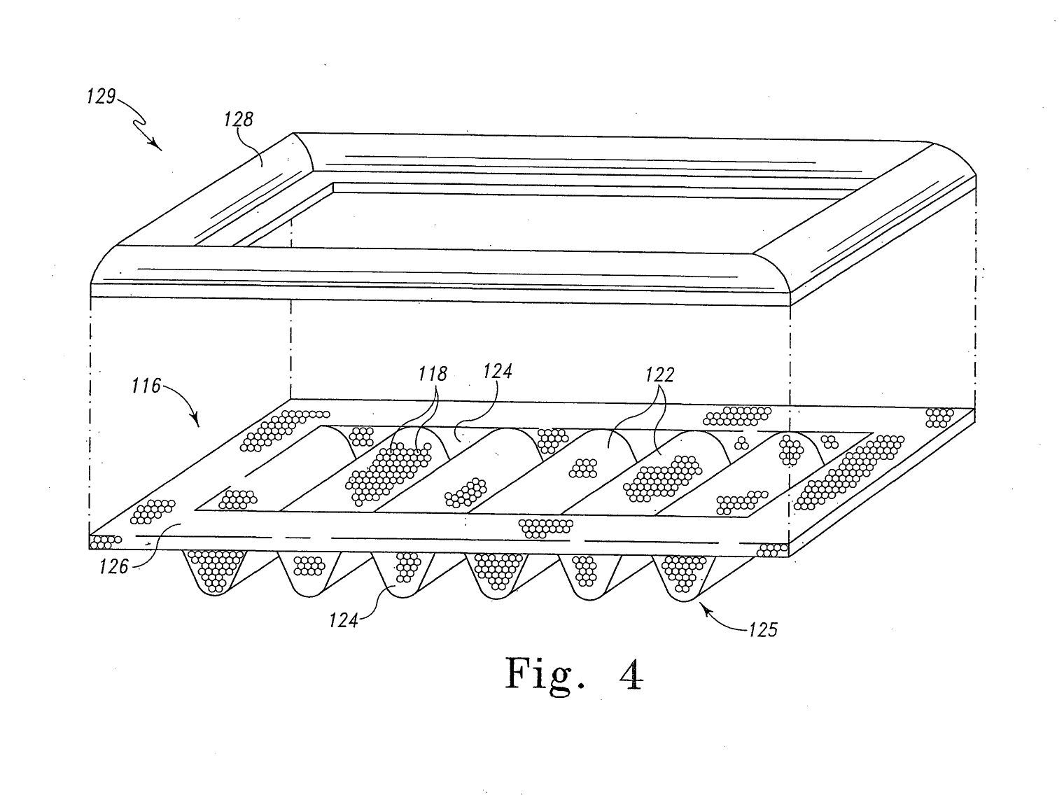

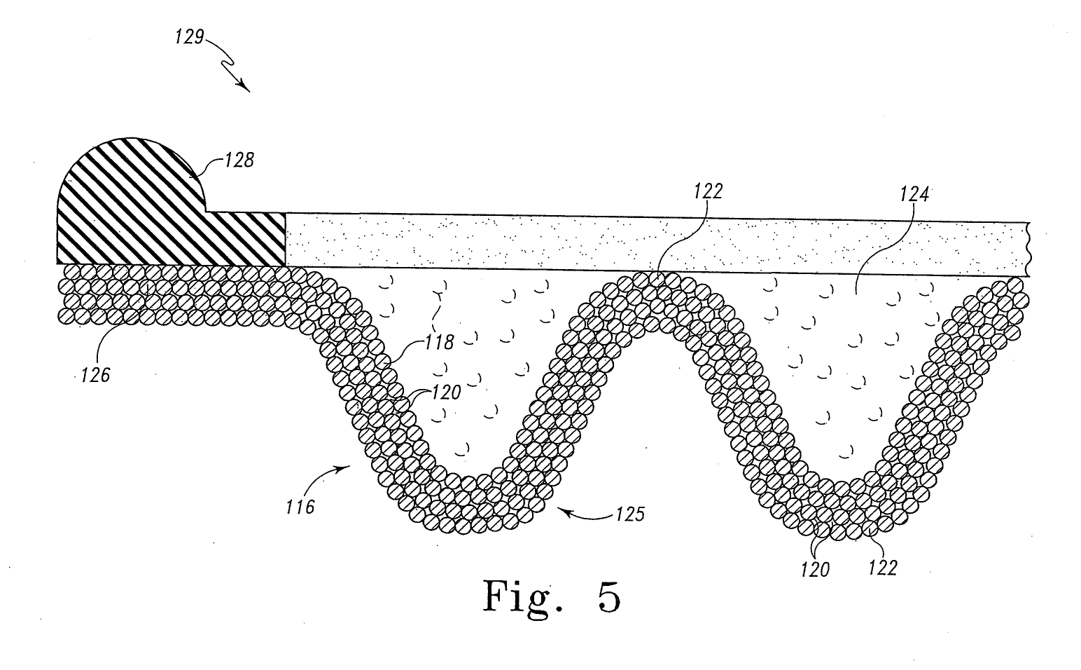

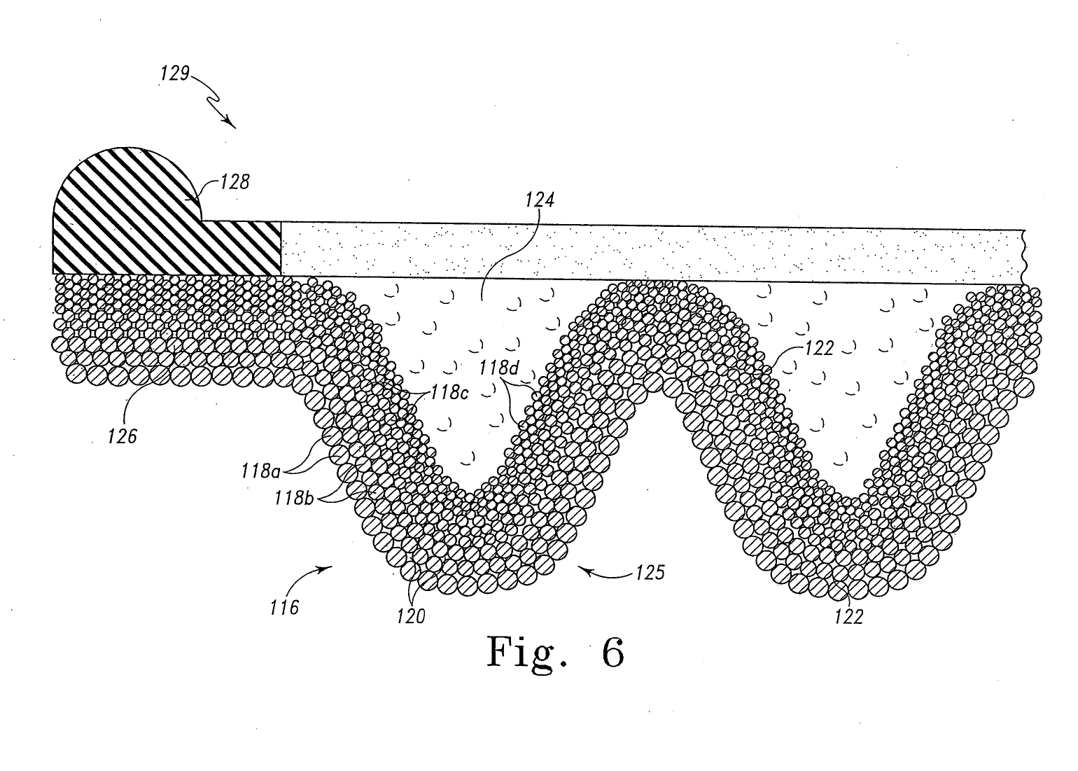

The pellets 118 may be of uniform or non-uniform size. For example, in FIGS. 4 and 5, the size of the pellets 118 of the filter medium 116 is uniform (e.g., diameter of about 0.125 inch or about 3 millimeters). In FIG. 6, the filter medium 116 has a number of layers (e.g., four) comprising pellets of different sizes to filter particles of different sizes. Exemplarily, a first layer comprises relatively large pellets 118a to filter relatively large particles. A second layer comprises pellets 118b smaller than the pellets 118a to filter particles smaller than the particles filtered by the first layer. A third layer comprises pellets 118c smaller than the pellets 118b to filter particles smaller than the particles filtered by the second layer. A fourth layer comprises relatively small pellets 118d smaller than the pellets 118c to filter particles smaller than the particles filtered by the third layer. Pellets of adjacent layers are sintered together.

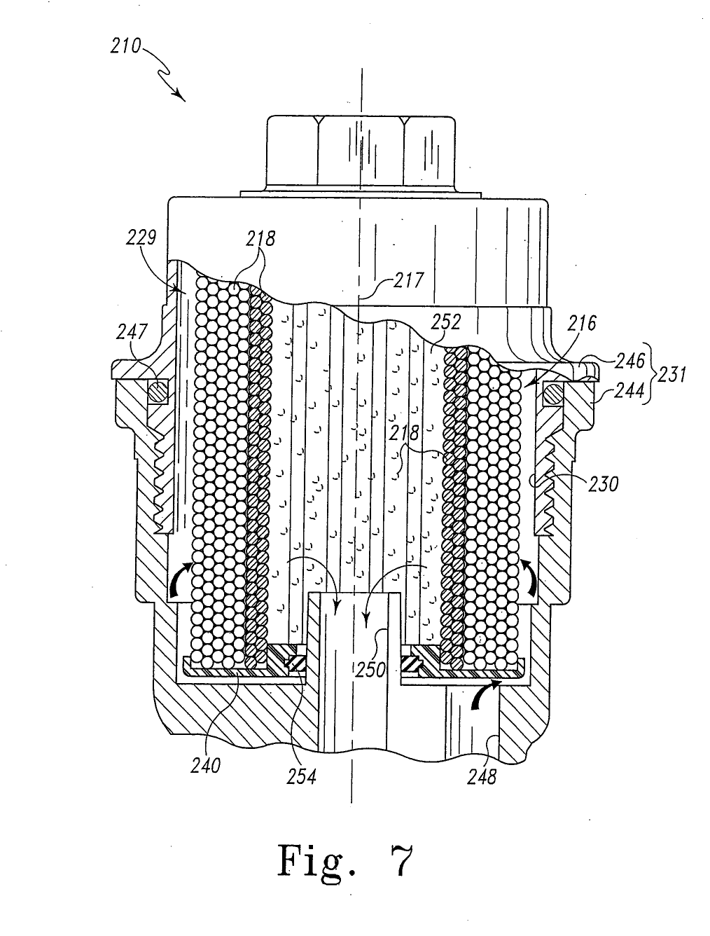

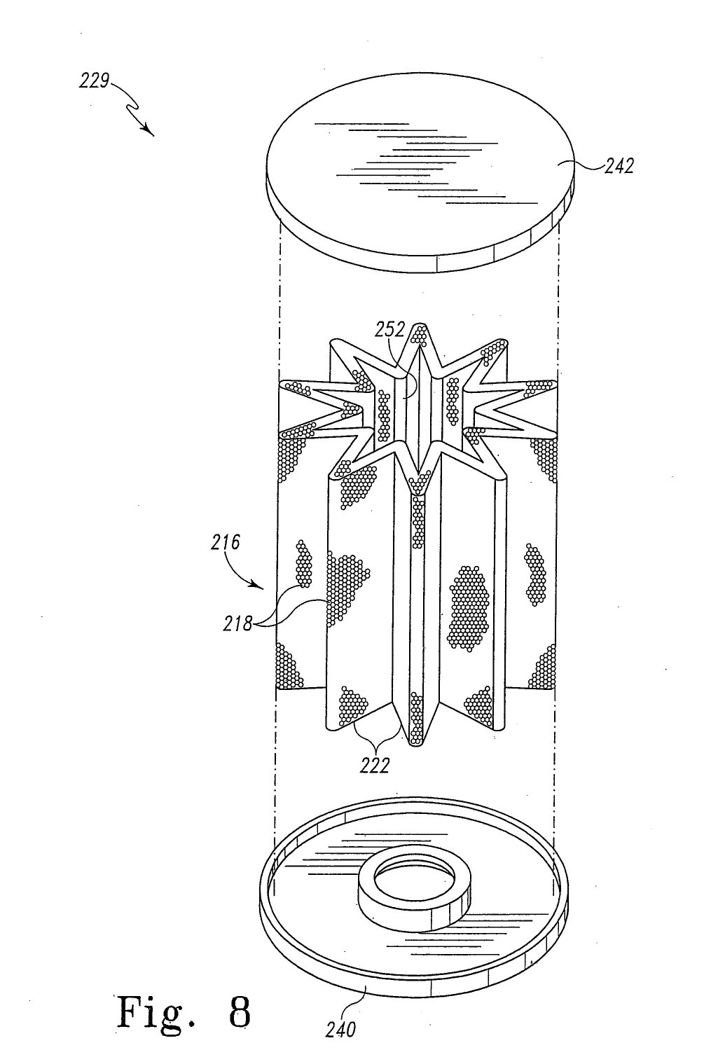

Referring now to FIGS. 7 and 8, according to another exemplary implementation, the automotive fluid filter 10 is embodied, for example, as an automotive liquid filter 210 and the automotive fluid filter medium 16 is embodied, for example, as a sintered pellet filter medium 216 shaped as a hollow cylinder having a central axis 217. The filter medium 216 comprises a plurality of pellets 218 that are sintered together and define a plurality of pores 220 between the pellets 218 to filter liquid (e.g., oil, transmission fluid, hydraulic fluid, fuel, lubricant, or the like) that is advanced through the pores 220. First and second end caps 240, 242 are secured to pellets 218 at opposite ends of the filter medium 216. Together, the filter medium 216 and end caps 240, 242 cooperate to provide a filter element 229. The sintered pellets 218 are made, for example, of propylene, polyphenylsulfone (for filtering transmission fluid, for example), or the like.

The filter element 229 is secured in position in a filter chamber 230 of a housing 231. The filter chamber 230 is defined between a housing base portion 244 and a housing cover portion 246 secured thereto by threaded engagement. An O-ring 247 establishes a sealed connection between the base and cover portions 244, 246. The base portion 244 is adapted to be secured to, for example, to an engine, a transmission, or the like and comprises an inlet 248 for admitting unfiltered liquid into the filter chamber 230 and an outlet 250 for discharging liquid from the filter chamber 230. The filter medium 216 is configured to filter unfiltered liquid flowing from the inlet 248 to the outlet 250 through the pores 220 defined between the pellets 218 and through a filtered liquid bore 252 defined by a radially inner surface of the filter medium 216. A gasket 254 made, for example, of rubber, urethane, or the like and secured to the end cap 240 establishes a sealed connection between the end cap 240 and the outlet 250 to block bypass of the filter medium 216 by the liquid.

The filter medium 216 is sufficiently rigid so that use of a center tube in the bore 252 to structurally reinforce the filter medium 216 is unnecessary. It is within the scope of this disclosure to include such a center tube in the bore 252.

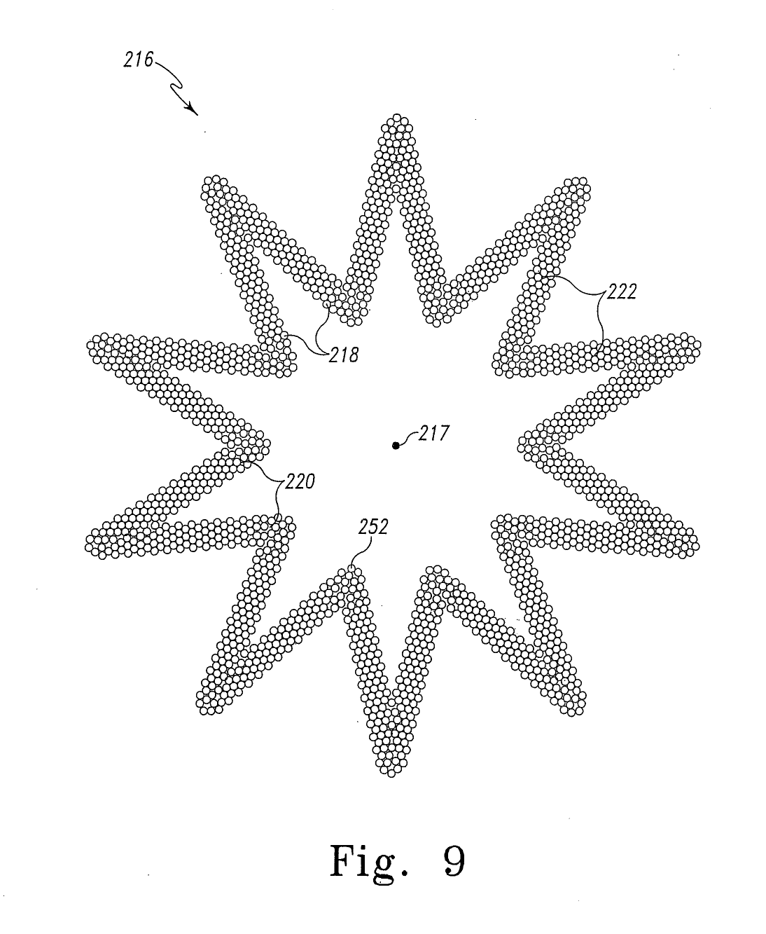

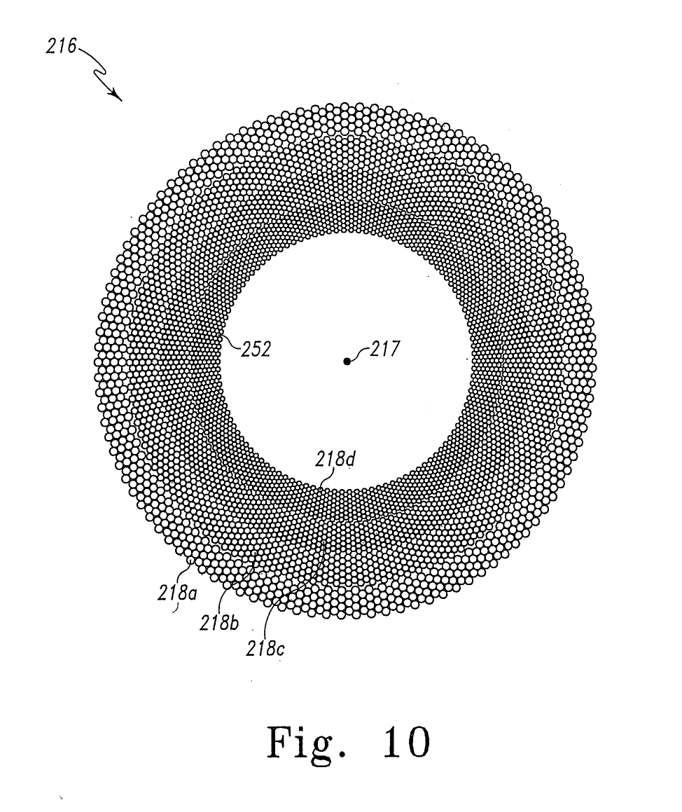

The filter medium 216 may or may not comprise pleats 222 provided by the pellets of the filter medium 216. For example, in FIGS. 8 and 9, the filter medium 216 comprises pleats 222 for increasing the filter surface area. In FIGS. 10-13, the filter medium 216 does not comprise pleats 222.

The pellets 218 may be of uniform or non-uniform size. For example, in FIGS. 8 and 9, the size of the pellets 218 of the filter medium 216 is uniform (e.g., diameter of about 0.125 inch or about 3 millimeters). In FIGS. 10-13, the filter medium 216 has a number of layers (e.g., four) comprising pellets of different sizes to filter particles of different sizes. Exemplarily, a first layer comprises relatively large pellets 218a to filter relatively large particles. A second layer comprises pellets 218b smaller than the pellets 218a to filter particles smaller than the particles filtered by the first layer. A third layer comprises pellets 218c smaller than the pellets 218b to filter particles smaller than the particles filtered by the second layer. A fourth layer comprises relatively small pellets 218d smaller than the pellets 218c to filter particles smaller than the particles filtered by the third layer.

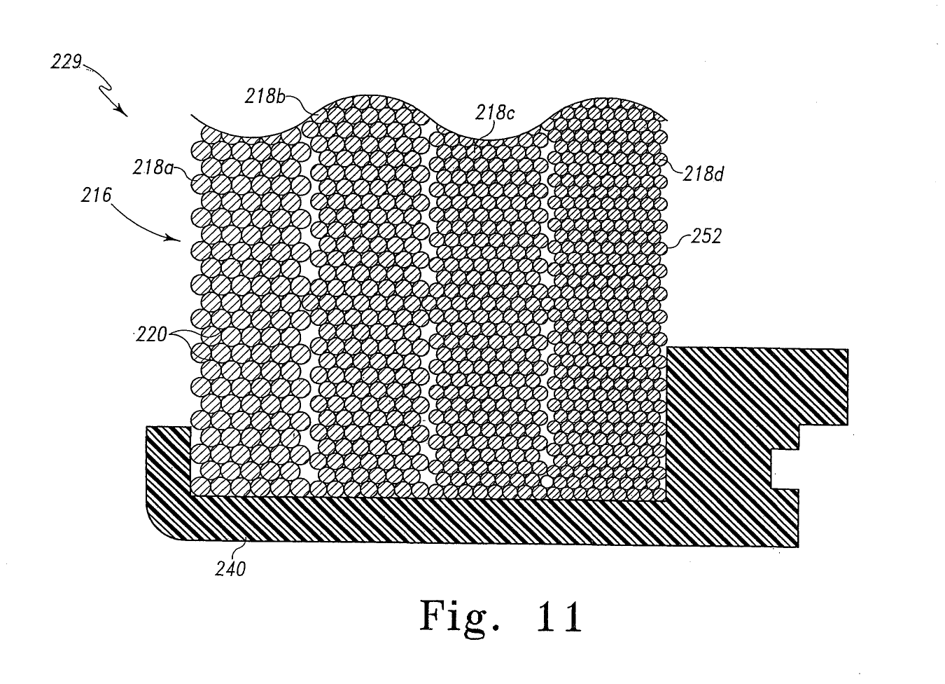

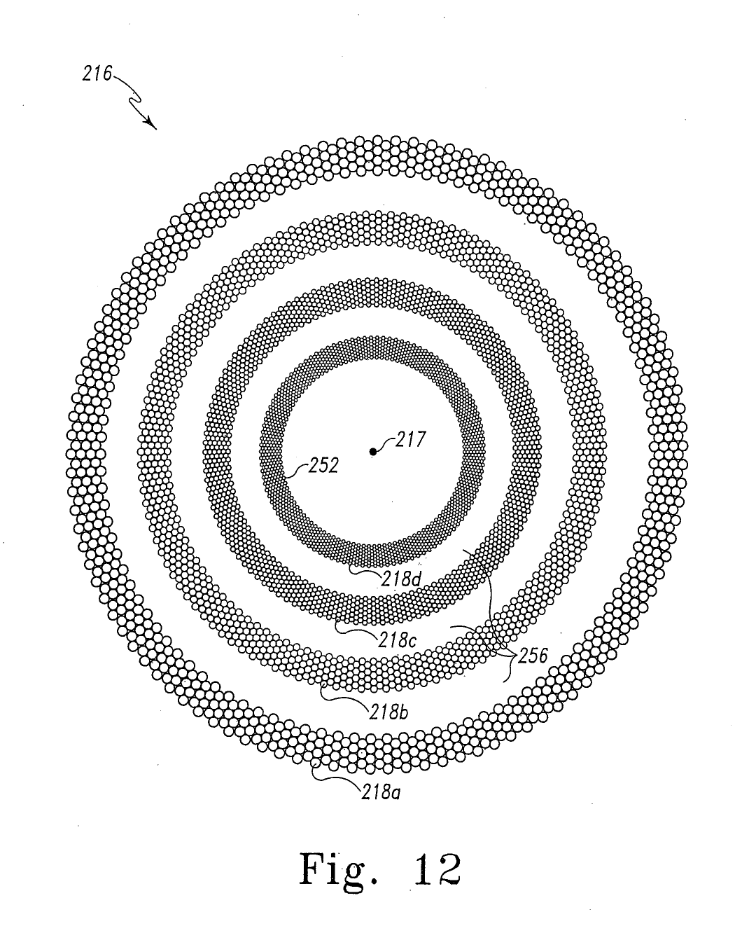

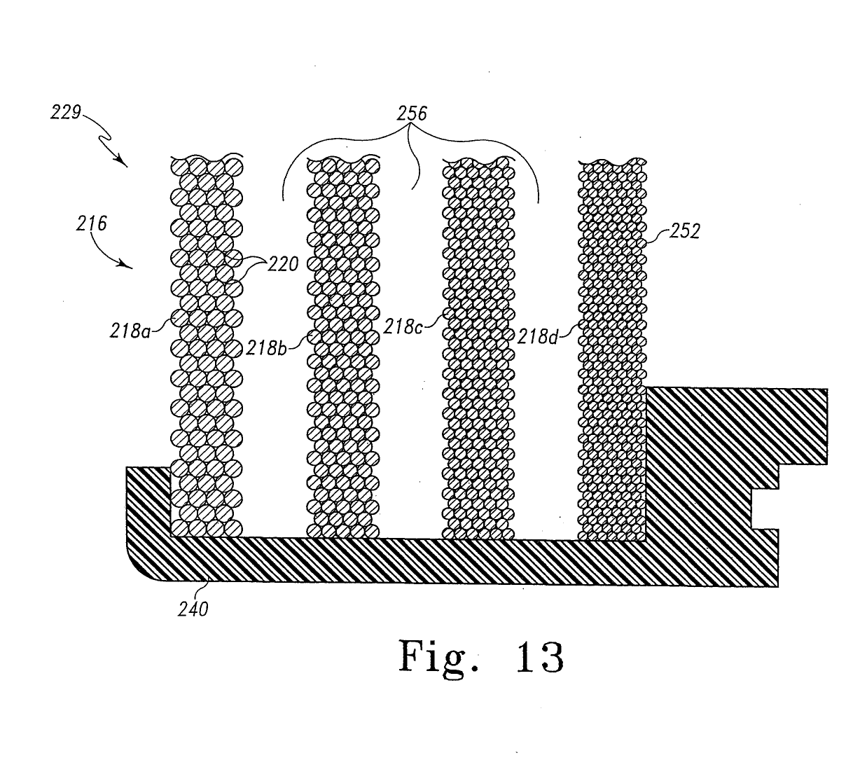

The pellets of adjacent layers may be sintered together as in FIGS. 10 and 11. On the other hand, the pellets of adjacent layers may be spaced apart from one another to define particle accumulation chambers 256 therebetween without any pellets to accumulate filtered particles in the chambers 256 as in FIGS. 12 and 13. In either case, pellets of each layer are secured to both end caps 242, 244, as suggested in FIGS. 11 and 13.

While the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure are desired to be protected.

There are a plurality of advantages of the present disclosure arising from the various features of the apparatus, method, and system described herein. It will be noted that alternative embodiments of the present disclosure may not include all of the features described yet still benefit from at least some of the advantages of such features. Those of ordinary skill in the art may readily devise their own implementations of an apparatus, method, and system that incorporate one or more of the features of the present disclosure and fall within the spirit and scope of the present invention as defined by the appended claims.

1. A method of filtering an automotive fluid comprising the step of advancing the automotive fluid through pores defined between pellets that are sintered together so as to filter the automotive fluid.

2. The method of claim 1, wherein the advancing step comprises advancing air through the pores.

3. The method of claim 1, wherein the advancing step comprises advancing automotive liquid through the pores.

4. The method of claim 1, wherein the advancing step comprises advancing oil through the pores.

5. The method of claim 1, wherein the advancing step comprises advancing transmission fluid through the pores.

6. The method of claim 1, wherein the advancing step comprises advancing fuel through the pores.

7. The method of claim 1, wherein the advancing step comprises advancing lubricant through the pores.

8. The method of claim 1, wherein the advancing step comprises advancing hydraulic fluid through the pores.
